(19) United States
(12) Patent Application Publication
(10) Pub. No.: US 2008/0145622 A1
(43) Pub. Date: Jun. 19, 2008

(54) POLYMER-BASED INTEGRATED THIN FILM CAPACITORS, PACKAGES CONTAINING SAME AND METHODS RELATED THERETO

(76) Inventors: Mihir K. Roy, Chandler, AZ (US); Islam A. Salama, Chandler, AZ (US); Yongki Min, Phoenix, AZ (US)

Correspondence Address: SCHWEGMAN, LUNDBERG & WOESSNER, P.A., P.O. BOX 2938, MINNEAPOLIS, MN, 55402, US

(21) Appl. No.: 11/610,601

(22) Filed: Dec. 14, 2006

(51) Int. Cl. B05D 5/12; B32B 9/04; B32B 3/10

(52) U.S. Cl. 428/195.1; 427/80; 428/704

(57) ABSTRACT

Some embodiments include thin film capacitors (TFC) formed on a package substrate of an integrated circuit package. The TFC include a polymer-based dielectric layer deposited directly on the package substrate. At least one of the TFC includes a first electrode layer, a second electrode layer, with the polymer-based dielectric layer located between the first and second electrode layers. Each of the first and second electrode layers is also formed individually and directly on the package substrate. Other embodiments are described and claimed.

### TECHNICAL FIELD

Embodiments relate generally to integrated thin film capacitor fabrication. More particularly, embodiments relate to integrated thin film capacitor packages in connection with microelectronic devices.

### TECHNICAL BACKGROUND

Many efforts have been taken to integrate thin film capacitors (TFC) into integrated circuit (IC) packages to improve IC performance through use of high dielectric constant (high-k) ceramic materials. A high-k ceramic TFC is typically fabricated separately from the organic substrate into which it is to be embedded due to high temperature processing requirements. The pre-formed TFC is then mounted or laminated onto the substrate of the package in a separate process. However, such a process requires careful handling of the TFC prior to lamination and a high degree of alignment accuracy during lamination.

Low temperature methods for depositing ceramic TFC in situ have also been developed, but the issue of a potential coefficient of thermal expansion (CTE) mismatch between the ceramic TFC and the organic substrate remains.

### BRIEF DESCRIPTION OF THE DRAWINGS

In order to depict the manner in which the embodiments are obtained, a more particular description of embodiments briefly described above will be rendered by reference to specific embodiments that are illustrated in the appended drawings. Understanding that these drawings depict only typical embodiments that are not necessarily drawn to scale and are not therefore to be considered to be limiting of its scope, the embodiments will be described and explained with additional specificity and detail through the use of the accompanying drawings in which:

FIG. 1 shows an apparatus having a thin film capacitor (TFC) according to an embodiment;

FIG. 2A is a cross-section elevation of a thin-film capacitor (TFC) assembly during processing according to an embodiment;

FIG. 2B is a cross-section elevation of the TFC assembly depicted in FIG. 2A after further processing according to an embodiment;

FIG. 2C is a cross-section elevation of the TFC assembly depicted in FIG. 2B after further processing according to an embodiment;

FIG. 2D is a cross-section elevation of the TFC assembly depicted in FIG. 2C after further processing according to an embodiment;

FIG. 2E is a cross-section elevation of the TFC assembly depicted in FIG. 2D after further processing according to an embodiment;

FIG. 2F is a cross-section elevation of the TFC assembly depicted in FIG. 2E after further processing according to an embodiment;

FIG. 2G is a cross-section elevation of the TFC assembly depicted in FIG. 2F after further processing according to an embodiment;

FIG. 2H is a cross-section elevation of the TFC assembly depicted in FIG. 2G after further processing according to an embodiment;

FIG. 2I is a cross-section elevation of the TFC assembly depicted in FIG. 2H after further processing according to an embodiment;

FIG. 3 shows a package having TFC formed on each side of a substrate portion of a substrate according to an embodiment;

FIG. 4 is a flowchart showing a method according to an embodiment;

FIG. 5 is a flow chart showing another method according to an embodiment; and

FIG. 6 shows a system according to an embodiment.

### DETAILED DESCRIPTION

Embodiments in this disclosure relate to a polymer-based integrated thin-film capacitor (TFC) and to a TFC that is part of a chip package. Embodiments also relate to methods of forming a TFC from a high-k polymer composite and to methods of using a polymer composite. Embodiments also relate to systems that incorporate a TFC.

The following description includes terms, such as upper, lower, bottom, top, first, second, etc., that are used for descriptive purposes only and are not to be construed as limiting. The embodiments of an apparatus or article described herein can be manufactured, used, or shipped in a number of positions and orientations. The terms “die” and “chip” generally refer to the physical object that is the basic workpiece that is transformed by various process operations into the desired integrated circuit device. A board is typically a resin-impregnated fiberglass structure that acts as a mounting substrate for the die. A die is usually singulated from a wafer, and wafers may be made of semiconducting, non-semiconducting, or combinations of semiconducting and non-semiconducting materials. A matrix polymer refers to a thermoplastic or melt-processable polymer. A low power radio frequency (RF) devices is typically a device having power less than about ten (10) watts and a frequency of up to about ten (10) GHz.

Reference will now be made to the drawings wherein like structures will be provided with like suffix reference designations. In order to show the structures of various embodiments most clearly, the drawings included herein are diagrammatic representations of integrated circuit structures. Thus, the actual appearance of the fabricated structures, for example in a photomicrograph, may appear different while still incorporating the essential structures of the illustrated embodiments. Moreover, the drawings show only the structures necessary to understand the illustrated embodiments. Additional structures known in the art have not been included to maintain the clarity of the drawings.

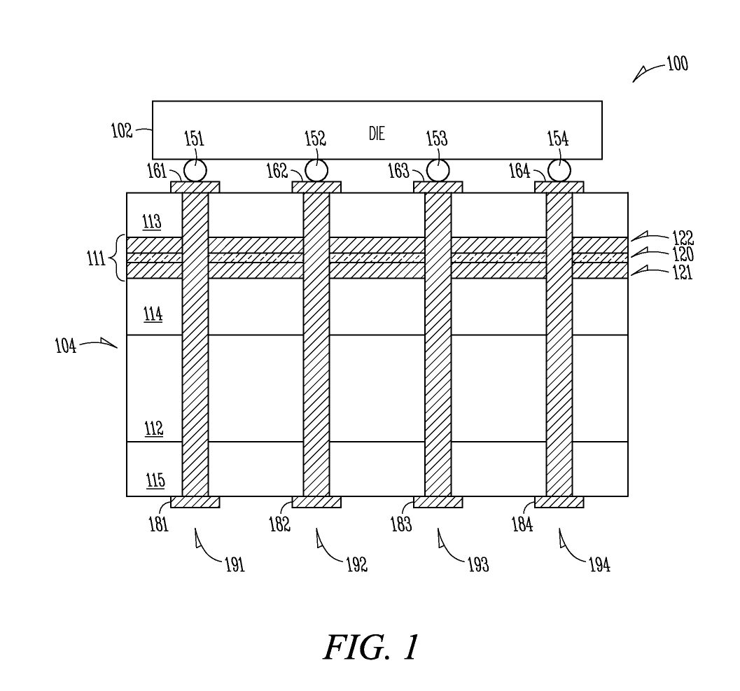

FIG. 1 shows a package 100 according to an embodiment. Package 100 may be an integrated circuit package. Package 100 includes a die 102 attached to a substrate 104. Substrate 104 may be called a package substrate or a package organic substrate. Die 102 may include one or more integrated circuits. In some embodiments, die 102 may include an integrated circuit to perform a function of a processor, a communication device, a memory device, or some combination thereof. Die 102 may include integrated circuits to perform other functions. In some embodiments, package 100 resides in a system or in a device such a computer or a communication device (e.g., a cellular phone) or any device capable of generating and/or reproducing music or sound, such as a portable entertainment device or other type of portable electronic device. Such devices may include any type of RF device, such as a low power RF device. Such devices may further include any type of wireless and/or portable device.

Package 100 includes conductive contacts or pads 161, 162, 163, and 164 on one side of substrate 104 and conductive contacts or pads 181, 182, 183, and 184 on another side of substrate 104. Package 100 also includes conductive paths or interconnects 191, 192, 193, and 194 extending between contacts 161 through 164 and contacts 181 through 184. Die 102 couples to substrate 104 through conductive elements, for example, through solder balls 151, 152, 153, and 154.

In a system or a device, for example, an RF transmitter, RF receiver or computer, conductive contacts 181 through 184 may be coupled to a platform such as a circuit board and/or an interposer (not shown) to allow die 102 to exchange information or data with other components through conductive paths 191, 192, 193, and 194. A group of the conductive paths 191 through 194 may be coupled to power terminals as positive and ground terminals of a power source. Another group of the conductive paths 191 through 194 may be coupled to other components of the system or device to transfer data. FIG. 1 shows package 100 with four conductive paths, 191 through 194, for example purposes. The number of conductive paths of package 100 may vary. For example, package 100 may include numerous conductive paths forming a high-density interconnect arrangement.

In the embodiment shown in FIG. 1, substrate 104 includes a core layer 112, and buildup layers 113, 114, and 115. Core layer 112 may include organic material. Buildup layers 113, 114, and 115 may include organic material. In some embodiments, one or more of the buildup layers 113, 114, and 115 may include a polymeric material or an Ajinomoto buildup film (ABF) manufactured by Ajinomoto Fine Techno Co., having offices in Kawasaki, Japan.

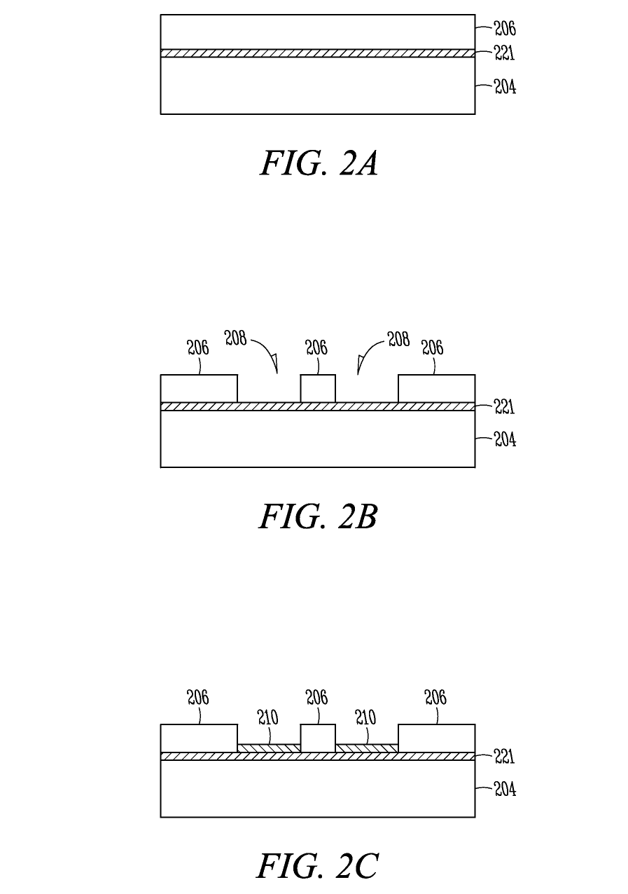

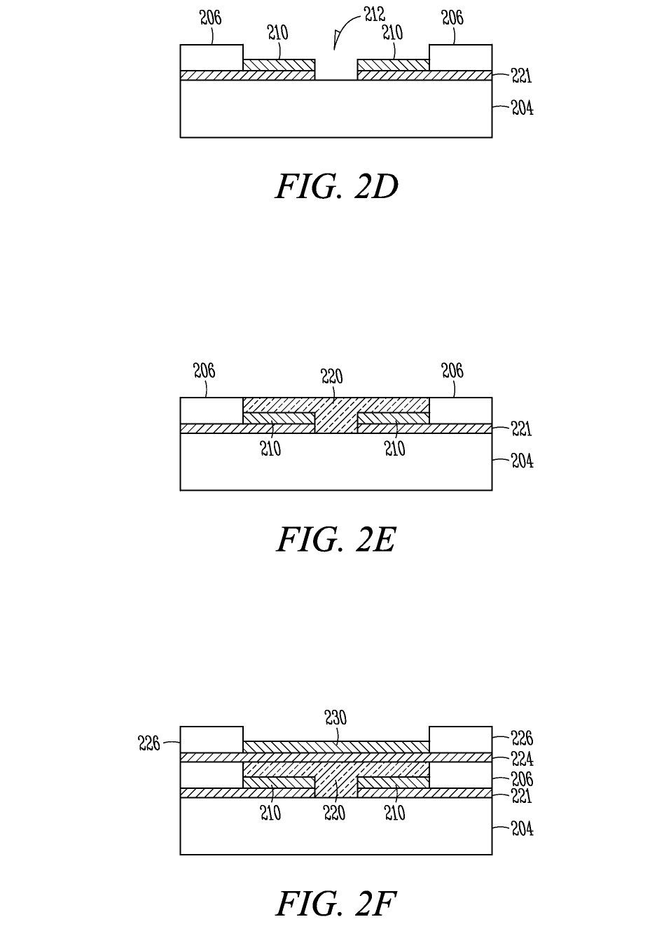

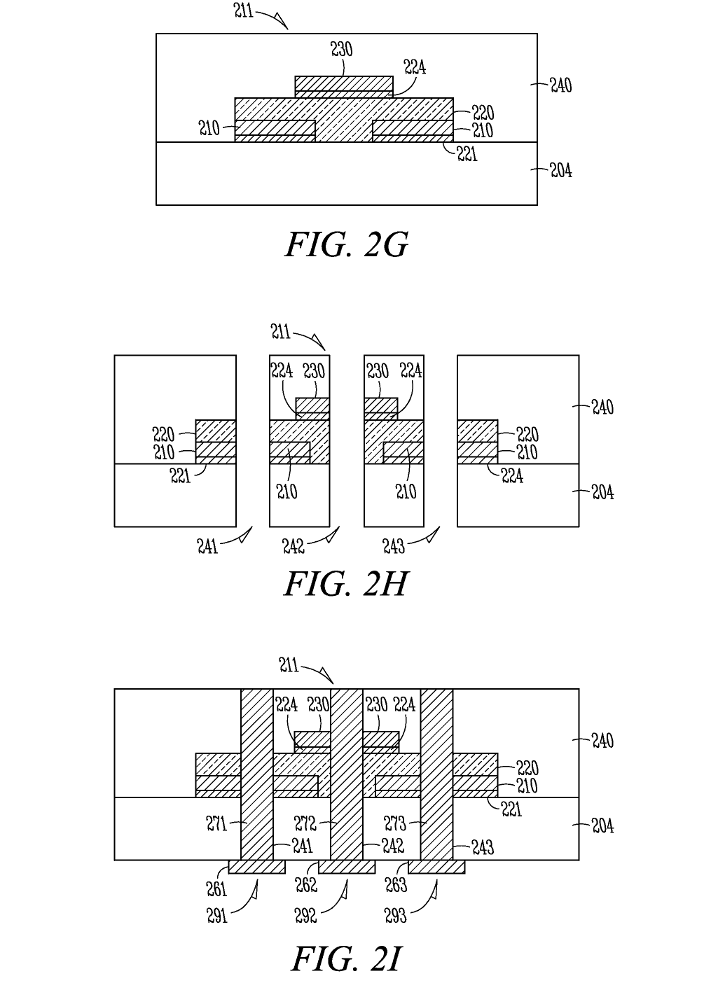

A number of TFC 111 are formed and embedded in substrate 104. As shown in FIG. 1, TFC 111 are embedded in substrate 104 between buildup layer 113 and other layers of substrate 104. TFC 111 are referred to as integrated TFC. For clarity, FIG. 1 shows a high-level diagram of TFC 111. Detail formation of some embodiments of TFC 111 are shown in FIG. 2A through FIG. 2I. In the description herein, TFC 111 are collectively called TFC 111. The term TFC, such as TFC 111, refers to either a single thin film capacitor or a group of multiple TFC. In FIG. 1, TFC 111 may be used in different ways. For example, one or more of the TFC 111 may be used as decoupling capacitors in a signal filtering or power distribution circuitry. Decoupling capacitors are used to reduce noise in the power or ground lines of high frequency devices, since they are capable of providing a stable signal or stable supply of power to the circuitry. TFC 111 may also be used to dampen power overshoot when an electronic device (e.g., a processor) is powered up, and to dampen power droop when the device begins using power.

TFC 111 includes conductive layers or capacitor electrode layers 121 and 122, and a dielectric layer 120. Conductive layers 121 and 122 may include copper, nickel, or other conductive materials. In some embodiments, at least one of the conductive layers 121 and 122 may be a foil or plated metal, with a thickness of between about 10 micrometers and about 30 micrometers.

In some embodiments, dielectric layer 120 may be formed by depositing a high-k polymer composite dielectric material on conductive layer 121 at a suitable temperature followed by curing of the material. (See description for FIG. 2E). Dielectric layer 120 may include a high dielectric constant (high-k) material, i.e., in the range of about 2000 to 5000 or more. However, in some embodiments, dielectric layer 120 may have a dielectric constant less than 2000, down to about 400. In other embodiments, dielectric layer 120 may have a dielectric constant greater than 5000, up to about 10,000.

Dielectric layer 120 may have a suitable thickness in the range of about 100 to 1000 Angstroms. A layer having a thickness that is greater or smaller than the above range can be used in other embodiments. In an embodiment, capacitance in the range of about 16 to about 18 nanofarad (nF)/cm² at a thickness less than about 0.5 micrometers. In an embodiment, the dielectric layer 120 is a polymer composite layer. A polymer composite layer may be less expensive than a ceramic layer. In an embodiment, the high-k polymer composite comprises a polymeric material blended with a filler of high dielectric constant in suitable proportions. In an embodiment, the filler is added in an amount sufficient to allow the dielectric constant to be at a minimum desired level. In an embodiment, the filler is added in an amount sufficient to allow the dielectric constant to be at a maximum desired level without causing percolation of the filler in the epoxy. In an embodiment, the filler is added to the polymeric material in amounts of between about 40 weight percent (wt %) and about 55 wt %.

In an embodiment, the polymeric material in the dielectric layer 120 includes any suitable type of epoxy, as the term is understood in the art. In an embodiment, a ferroelectric polymer epoxy is used. In an embodiment, the ferroelectric polymer epoxy includes any material capable of providing sufficient capacitor density. Such materials may include, but are not limited to, nylon-11 (a synthetic polyamide), polyvinylidene flouride (PVDF), poly(vinylidene fluoride-trifluoroethylene ((P(VDF-TrFE)), poly(vinylidene fluoride-tetrafluorethylene), and combinations thereof. In an embodiment, the polymeric material is an electrostrictive material, which may be obtained by subjecting a polymer to high energy electron irradiation as is known in the art. In an embodiment, the polymeric material in the dielectric layer 120 is a relaxor ferroelectric material having a high room-temperature dielectric constant of at least about 40 and a electrostriction or strain greater than about four (4) %. In an embodiment, the relaxor ferroelectric material is an electrostrictive P(VDF-TrFE) copolymer, such as a 50/50 mol % copolymer.

The filler may be of micrometric particle size. In an embodiment, the filler may be any suitable type of monomer or oligomer having the desired properties, such as a high dielectric constant. In most embodiments, the micrometric-sized particles do not contribute to higher conduction currents in the overall composite when under application of an electric field. Typically, any type of fillers or second phase can produce interfacial charge if they do not obey Maxwell-Wagner law. Examples of fillers that lead to higher conduction current due to a Maxwell-Wagner interfacial charge buildup across the interface of the materials include titanium oxides, such as barium titanium oxide and lead titanium oxides. These types of fillers actually can reduce the substrate's ability to insulate.

In a particular embodiment, the filler in the dielectric layer 120 includes any type of metallophthalocyanine (MPc) oligomer having the desired properties, such as a sufficiently high dielectric constant. The filler may have a dielectric constant in the range of about 2000 to 5000 or more. However, in some embodiments, the filler may have a dielectric constant less than 2000, down to about 400. In other embodiments, the filler may have a dielectric constant greater than 5000, up to about 10,000 or higher. In an embodiment, the filler is a metallophthalocyanine oligomer with a dielectric constant greater than about 10⁴ up to 10⁵, although some dielectric losses may occur upon processing due to long range intermolecular hopping of electrons. Such losses may be minimized within the polymer matrix, which forms insulation layers. The overall dielectric constant of the polymer composite is determined by the rule of mixture.

Oligomers used as fillers may have several hexagonal and pentagonal rings with delocalized double bonds, i.e., delocalized electrons of the pi bonds. The presence of delocalized double bonds, as well as the presence of several hexagonal and pentagonal rings drives such oligomers to redistribute electrons under the electric field, thereby reducing the Maxwell-Wagner interfacial polarization. In an embodiment, the oligomer has several benzene rings and multiple nitrogen-containing carbon rings with delocalized double bonds. In an embodiment, the oligomer may have four or more nitrogen-containing carbon rings.

In an embodiment, the oligomer is a metal phthalocyanine with nitrogen-containing carbon rings. The precise number of nitrogen-containing carbon rings depends on the valence of the metal. In an embodiment, there are five (5) nitrogen-containing carbon rings. In an embodiment, there are four (4) nitrogen containing carbon rings. The various types of phthalocyanine polymers include those in which the phenylene rings of adjacent monomers are connected by single bonds, i.e., biphenyl; monomers joined together by substituents attached to the phenylene ring; fused oligomers which share the phenylene rings of the phthalocyanines; and stacked compounds in which the phthalocyanine molecules are connected at the central metallic atom. In general, multiple sheet oligomers are stacked to form stacked compounds.

In an embodiment, the oligomer is a sheet oligomer which comprises four monomers joined together via benzene rings and having the following structure:

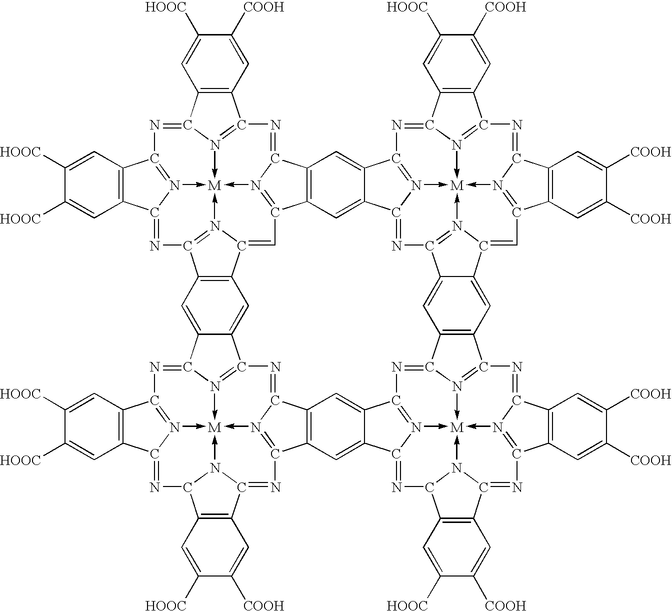

wherein M=Cu, Cr, Mn, Fe, Co or Ni

The oligomer, such as the above oligomer, may be synthesized according to any methods known in the art and dried by any suitable method to obtain microscopic particles. In an embodiment, M=Cu such that the oligomer is copper phthalocyanine (CuPc), which is synthesized by any known method. In an embodiment, the CuPc (or nickel phthalocyanine or cobalt phthalocyanine) is synthesized by the solution method described in Achar, B. N., et al, Phthalocyanine polymers. II. Synthesis and characterization of some metal phthalocyanine sheet oligomers, J. Polymer. Sci. Poly. Chem, 20, 1785-1790 (1982). The Achar solution method for synthesizing CuPc, as described on pages 1788-1789 of Achar, et al, includes grinding together suitable amounts of copper sulphate pentahydrate (e.g., about 6.1 grams (g)), pyromellitic dianhydride (e.g., about 9.6 g), urea (e.g., about 30 g), ammonium chloride (e.g., about 2.5 g) and ammonium molbydate (about 0.5 g) and placing the ground material in a three-necked flask containing nitrobenzene. The flask is maintained at a temperature of approximately 180-185° C. for approximately 12 hours. The solid material is then boiled with hydrochloric acid (e.g., about 500 mL of 2 Normal (N) hydrochloric acid saturated with sodium chloride) for about three (3) minutes, cooled to room temperature and filtered. The resulting solid is treated with potassium hydroxide (e.g., about 500 mL of 2N sodium hydroxide that contains about 200 g of sodium chloride) and heated at about 90° C. until the evolution of ammonia stops. The product after filtration is treated with hydrochloric acid (e.g., about 500 mL of 2N) and separated by centrifugation. The solid is dissolved in sodium hydroxide (e.g., about 0.1 N) and filtered to separate the insolubles. The desired compound is precipitated with hydrochloric acid (e.g., about two (2)N) and separated by centrifugation. Dissolution in sodium hydroxide and precipitation with hydrochloric acid is repeated twice in the Achar method. The compound is then washed with water until chloride-free. The above-described Achar method of purification treatment ensures removal of excess metal ions, remaining pyromellitic acid and the by-products of reaction, although any suitable method of purification may be used. The resulting product may be dried over phosphorus pentoxide in a vacuum. The particle size of the powder, as measured by scanning electron microscopy, is below about one (1) micrometer down to 0.01 nanometers. In other embodiments, the particle size of the filler may be greater, up to a few microns in size or greater, but should not be so large as to be larger than the thickness of the dielectric film layer 112.

MPc particles, such as CuPc particles, may be mixed with a polymeric material to produce a high-k polymer composite material. In an embodiment, the copolymer is first dissolved in a solvent, such as dimethylformamide (DMF) according to known methods and the desired amount of filler, such as MPC particles, is added. The solution is stirred via any suitable method in order to disperse the filler. In an embodiment, sonication using one or more transducers at a frequency, duration and power sufficient to cause adequate dispersion of the filler in the solution is used. Adequate dispersion is obtained when chaotic mixing is achieved. In most embodiments, the resulting mixed solution has a viscosity suitable for deposition onto the substrate at room temperature. However, in some embodiments, it may be desirable to deposit the material at a temperature higher than room temperature as long as the viscosity remains suitable

In an embodiment, the mixed solution may then be directly deposited on a substrate and cured by methods known in the art. Alternatively, the copolymer matrix may first be made into an electrostrictive polymer by methods known in the art. In an embodiment, the composite is irradiated at an elevated temperature, such as about 100° C., with electrons at a suitable energy level, such as about 1.2 milli electronvolts (MeV), for a time sufficient to produce an electrostrictive material, but not so long as to dry the material into a film, such that the material maintains an acceptable viscosity, i.e., remains sufficiently tacky or moist for deposition onto the substrate. At this point the material can be stored under proper conditions or can be used immediately in the process.

The CTE of the various high-k polymer composites discussed herein, for use in the dielectric layer, is in the range of about 12 to about 30×10⁻⁶/° C. The CTE of most substrates 104 is comparable, thus eliminating or reducing a potential CTE mismatch between the dielectric layer 120 and the substrate 104. Additionally, the expensive ceramic film patterning process is eliminated

In FIG. 1, each of the components of TFC 111, such as conductive layers 121 and 122, and dielectric layer 120, is formed directly on and embedded in substrate 104 without a lamination process such that none of the portions or components of TFC 111 is pre-formed and then laminated onto substrate 104.

In some embodiments, TFC 111 may be formed in an in-situ process such that each of the components of TFC 111 is formed individually and directly on one or more layers of substrate 104. For example, in the in-situ process, conductive layer 121 may be formed directly on core layer 112, and buildup layers 114 and 115. In the in-situ process, conductive layer 122 may be formed directly on dielectric layer 120, while dielectric layer 120 is over conductive layer 121, core layer 112, and buildup layers 114 and 115. The in-situ process for forming TFC 111 directly on substrate 104 may simplify fabrication process and reduce fabrication time.

In some embodiments, one or more of layers of package 100 may be omitted. For example, buildup layer 114 may be omitted such that such that TFC 111 may be formed directly on core layer 112.

FIG. 1 shows TFC 111 formed above core layer 112. In some embodiments, TFC 111 may be formed below core layer 112. For example, TFC 111 may be formed between core layer 112 and buildup layer 115. In some embodiments, besides TFC 111, one or more additional TFC may be formed and embedded in substrate 104.

FIG. 2A through FIG. 2I show various processes of forming a TFC according to an embodiment.

FIG. 2A shows a substrate portion 204, a first conductive layer 221 and a resist layer 206. Substrate portion 204 may be a portion of a package substrate such as substrate 104 of package 100 of FIG. 1, including any type of dielectric substrate. Substrate portion 204 may include a buildup layer, or a core layer, or a combination of a core layer and at least one buildup layer of a package substrate. For example, using FIG. 1 as a reference, substrate portion 204 of FIG. 2A may include a buildup layer such as buildup layer 114, or a core layer such as core layer 112, or a combination of layers such as core layer 112 and at least one of the buildup layers 114 and 115.

Substrate portion 204 may include an organic material. In some embodiments, substrate portion 204 may include at least one polymer layer. In an embodiment, first conductive layer 221 is a seed layer which may be formed by electroless plating or by other techniques known in the art. In other embodiments, first conductive layer 221 may be formed by deposition of a conductive material on substrate portion 204. First conductive layer 221 may include a single conductive material or a compound of multiple materials. In some embodiments, first conductive layer 221 may include copper and/or nickel. In an embodiment, the material is compatible with the dielectric layer 220 (FIG. 2E). Such materials include, but are not limited to, tungsten, an aluminum/silicon/copper blend or any other highly conductive metal or metal combination. In some embodiments, first conductive layer 221 has a thickness of about 10 to 30 micrometers. A first conductive layer 221 having a thickness that is greater or smaller than the above range may be used in other embodiments. In the embodiment shown in FIG. 2A, first conductive layer 221 is unpatterned such that it has no openings.

In an embodiment, the resist material in resist layer 206 is any liquid resist applied by a coating process known in the art for making organic substrates or packages. In an embodiment, the resist material is any dry film resist applied by a lamination process known in the art for making organic substrates or packages. Resist materials may be polymerized or hardened by exposure to oxygen, evaporation of a solvent, heating, or other suitable methods, depending on the resist material. For purposes herein, the resist material does not need to be photosensitive, but in some embodiments, photosensitive resist materials can be used.

In FIG. 2B portions of resist layer 206 have been removed to create first openings 208 which expose portions of first conductive layer 221 as shown. In an embodiment, resist layer 206 is a photosensitive resist layer which was exposed and developed as is known in the art, leaving only that portion of the resist which was exposed to a light source. These exposed portions of first conductive layer 221 are in locations where traces are to be added by plating and are part of a bottom capacitor electrode layer. In other embodiments, there is no resist layer 206. However, use of a resist layer allows location-specific electroplating as is known in the art.

A plating operation, such as electrolytic copper plating as is known in the art, adds material to first conductive layer 221 in the area of first openings 208 in FIG. 2B to produce traces 210 as shown in FIG. 2C. Other metals may also be plated. In an embodiment, the materials are compatible with dielectric layer 220 (FIG. 2E). Such materials include, but are not limited to, tungsten, an aluminum/silicon/copper blend or any other highly conductive metal or metal combination. In an embodiment, each trace 210 has a thickness in a range of about one (1) to ten (10) microns. A trace 210 having a thickness that is greater or smaller than the above range may be used in other embodiments.

In the embodiment shown in FIG. 2D, a portion of first resist layer 206 has been removed using resist stripping, as the term is understood in the art, to produce a second opening 212. In some embodiments, resist stripping is accomplished by wet-chemical processing such as exposure to a suitable solvent. In an embodiment, the resist material is a photosensitive resist material which is stripped by treatment with a plasma using ashing, as that term is understood in the art. The resist stripping was followed by a short etch operation, such as flash wet etching, to make the second opening 212 on first conductive layer 221. This was followed by addition of a second resist layer (not shown) in second opening 212 which was also removed by methods known in the art (e.g., selectively exposed and developed), thus forming the bottom electrode.

FIG. 2E shows a dielectric layer 220 formed on traces 210. As shown in FIG. 2E, a portion of first conductive layer 221 (between the two traces 210) has been removed using methods known in the art, such that dielectric layer 220 directly contacts substrate layer 204.

Dielectric layer 220 may be formed by depositing a dielectric material directly onto the traces 210 and first conductive layer 221. As discussed herein, the dielectric layer 220 may be made from a high-k polymer composite material, such as a polymeric epoxy containing CuPc particles. The dielectric layer 220 may be deposited in-situ by squeezing the material into the existing opening or openings with a squeegee as is known in the art, using a mask or stencil to block off areas where no dielectric material is desired. Other examples of techniques for forming dielectric layer 220 include, but are not limited to non-vacuum techniques such as spray painting, roller printing and the like. In some embodiments, dielectric layer 220 has a thickness of about 100 to 1000 Angstroms.

Dielectric layer 220 may be deposited or applied at a temperature such that thermal damage to layers underneath dielectric layer 220 may be avoided. In some other embodiments, dielectric layer 220 may be applied at about room temperature, for example, at about 25° C. In some embodiments, dielectric layer 220 may be applied at temperatures higher than room temperature, although not so high as to damage the substrate portion 204. In an embodiment, the dielectric layer 220 is applied at temperatures up to about 100° C.

In order to adhere properly, dielectric layer 220 is then cured at a suitable temperature, such as between about 120 and about 200° C. In some embodiments, substrate portion 204 may have a low melting point such that thermal damage may happen to substrate portion 204 when dielectric layer 220 is cured at temperatures greater than about 200° C. Therefore, in most embodiments, curing dielectric layer 220 at a temperature of about 200° C. or lower may prevent thermal damage to layers underneath dielectric layer 220. Further, the structure of FIG. 2E may be configured to assist in dissipating or transferring heat that is generated during a subsequent process to prevent thermal damage to substrate portion 204. For example, heat may be transferred to first conductive layer 221 during curing of the dielectric layer 220, thereby reducing the amount of generated heat that may affect substrate portion 204. In an embodiment, dielectric layer 220 may be cured using methods and energy sources known in the art including one or more of thermal energy, microwave energy, electromagnetic energy (e.g., laser beam), and the like. Dielectric layer 220 is then ground using conventional methods until sufficiently smooth.

FIG. 2F shows a second conductive layer 224 and a second resist layer 226 with a portion removed (e.g., exposed and developed) for a top electrode, after which a plating operation produced a trace 230 which can be made from any suitable metal as discussed herein. The second conductive layer 224 is considered a seed layer as that term is understood in the art.

FIG. 2G also shows a structure of a TFC 211. The second conductive layer 224 has now been patterned as shown. The dielectric layer 220 in the TFC 211 is surrounded on a bottom side by a bottom capacitor electrode layer of TFC 211, which includes a portion of substrate 204 and traces 210 as shown. The dielectric layer 220 in the TFC 211 is surrounded on a top side by a top capacitor electrode layer of TFC 211 by second conductive layer 224 and a portion of barrier layer 240. In an embodiment, barrier layer 240 is an ABF layer deposited by methods known in the art after stripping of the first resist layer 206 and second resist layer 226 (shown in FIG. 2F) followed by etching. This action was followed by pressing and curing as is known in the art. Barrier layer 240 allows the top capacitor electrode layer of TFC 211 to connect to desired power connections.

FIG. 2H shows vias 241, 242 and 243 formed in barrier layer 240 and substrate 204. The vias 241, 242 and 243 may also be formed through other layers (not shown) on top of barrier layer 240. The vias 241, 242 and 243 may be added to the electrode by drilling, e.g., laser drilling, or by other methods known in the art. FIG. 2H also shows TFC 211. Additional build up of the substrate may continue beyond these steps as is known in the art.

FIG. 21 shows filled vias 241, 242 and 243 which are part of conductive segments 271, 272 and 273, respectively. At least a portion of the conductive segments 271, 272 and 273 or other conductive segments not shown may be formed before or after first conductive layer 221 is formed. The material for conductive segments 271, 272 and 273 may be different from the conductive material for first conductive layer 221 and second conductive layer 224. As shown in FIG. 21, conductive segments 271, 272 and 273 may extend through the substrate 204 to contact other electrical connections at the bottom side of the substrate 204, such as conductive contacts or pads 261, 262 and 263, respectively. In other embodiments, the conductive contacts may be within the substrate 204. In the embodiment shown in FIG. 21, conductive segments 271, 272 and 273 are part of conducive paths 291, 292 and 293, respectively. In some embodiments, conductive paths 291, 292 and 293 of FIG. 21 may be a part of conductive paths, such as conductive paths 191, 192 and 193 of FIG. 1. Likewise, conductive contacts 261, 262 and 263 of FIG. 2I may be conductive contacts 161, 162 and 163 of FIG. 1. Substrate 204 may be a package substrate, such a substrate 104 of package 100 of FIG. 1.

The components shown in FIGS. 2A-2I, including TFC 211 are formed according to an example order. In some embodiments, the components, including TFC 211 may be formed in an order different from the order described herein. Multiple TFC such as multiples of TFC 211 of FIGS. 2G, 2H and 2I may be formed in a process similar to that described in FIGS. 2A through 2I.

As described in FIGS. 2A through 2I, the entire TFC 211 is formed and embedded in substrate 204 by separately or individually forming each component of TFC 211 directly on substrate 204. As a result, no lamination process is needed to form TFC 211 such that none of the portions or components of TFC 211 are pre-formed and then laminated onto substrate 204. Additionally, use of a polymer-based dielectric material in the dielectric layer 220 reduces the chance for CTE mismatch with substrate 204.

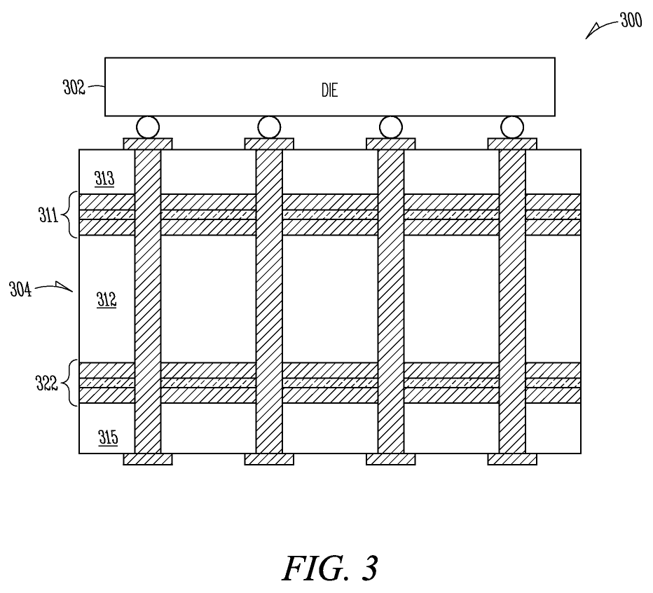

FIG. 3 shows a package having an integrated TFC formed on both sides of a substrate portion of a substrate according to an embodiment. Package 300 includes a die 302 attached to a substrate 304. Substrate 304 includes substrate portions 312, 313, and 315, a TFC 311 formed on one side of substrate portion 312, and a TFC 322 formed on another side of substrate portion 312. Each of the substrate portions 312, 313, and 315 may include one or more organic layers. Each of the TFC 311 and TFC 322 may represent either a single TFC or a group of multiple TFC having a high-k polymer-based dielectric layer. As shown in FIG. 3, both TFC 311 and TFC 322 are embedded in substrate 304. In some embodiments, one or both of TFC 311 and TFC 322 may be formed in a process similar to the process described in FIG. 2A through FIG. 2I.

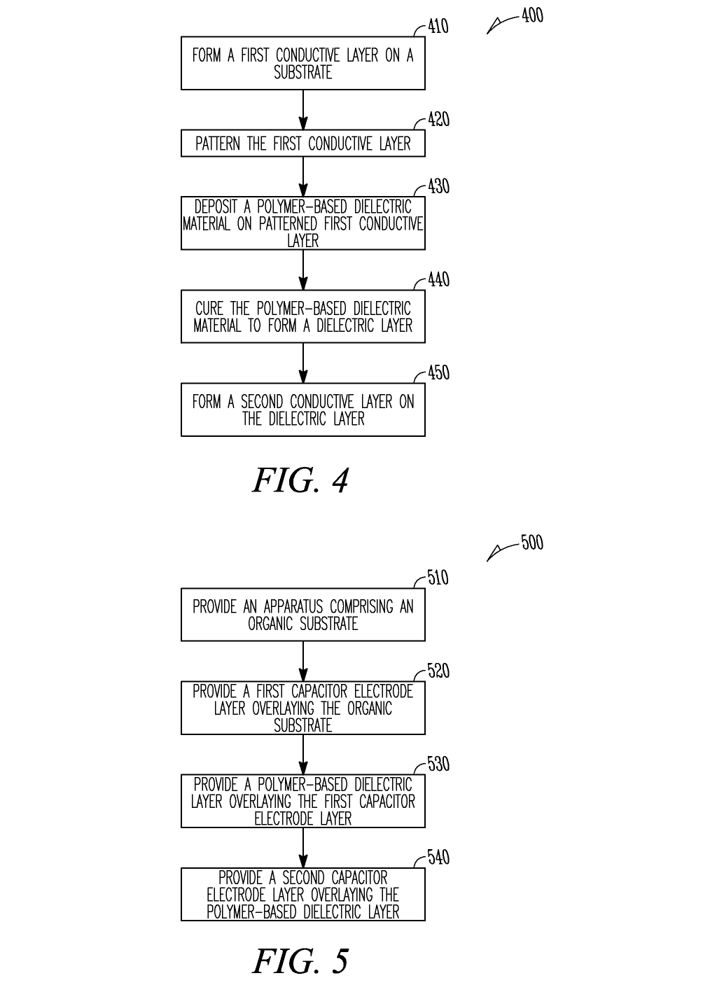

FIG. 4 is a flowchart of a method according to an embodiment. Method 400 forms an integrated TFC directly on a substrate without pre-forming an entire TFC and then laminating the entire pre-formed TFC onto the substrate. Method 400 forms each component of the TFC individually and directly on the substrate in an in-situ process. In method 400 of FIG. 4, activity 410 forms a first conductive layer on a substrate of a package. Activity 420 patterns the first conductive layer. Activity 423 deposits a polymer-based dielectric material on the first conductive layer. Activity 440 cures the polymer-based dielectric material to form a dielectric layer. Activity 450 forms a second conductive layer on the dielectric layer. Method 400 may include the embodiments of forming the TFC such as TFC 111 of FIG. 1, TFC 211 of FIGS. 2G, 2H and 2I and 311 of FIG. 3. The individual activities of method 400 do not have to be performed in the order shown or in any particular order. Some activities may be repeated, and others may occur only once.

Various embodiments may have more or fewer activities than those shown in FIG. 4. For example, traces may be formed on the first conductive layer prior to the polymer-based dielectric material being deposited, such that the material is deposited on the first conductive layer and the traces. Additional activities may include forming traces on the second conductive layer, patterning the second conductive layer, forming a build-up layer and forming vias to allow connections to the first and second conductive layers. Additionally, the high-k polymer composite material for the dielectric layer may be produced in any suitable manner and used in the process as needed.

FIG. 5 is a flowchart of a method according to an embodiment. Method 500 provides a method of using a polymer composite in a TFC. In method 500 of FIG. 5, activity 510 provides an apparatus comprising an organic substrate. Activity 520 provides a first capacitor electrode layer overlaying the organic substrate. Activity 530 provides a polymer-based dielectric layer overlaying the first capacitor electrode layer. Activity 540 provides a second capacitor electrode layer overlaying the polymer-based dielectric layer. Method 500 may include the embodiments of using a polymer composite in a TFC such as TFC 111 of FIG. 1, TFC 211 of FIGS. 2G, 2H and 2I and 311 of FIG. 3. The individual activities of method 500 do not have to be performed in the order shown or in any particular order. Some activities may be repeated, and others may occur only once. Various embodiments may have more or fewer activities than those shown in FIG. 5.

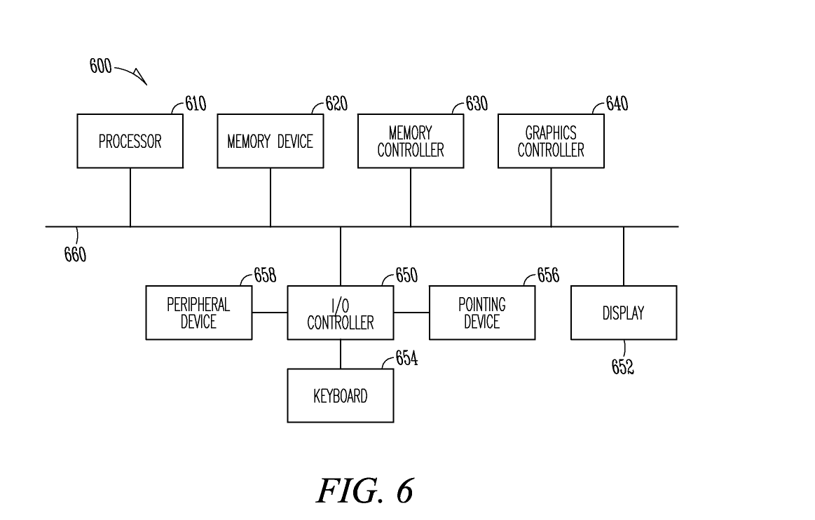

FIG. 6 shows a system according an embodiment. System 600 includes a processor 610, a memory device 620, a memory controller 630, a graphics controller 640, an input and output (I/O) controller 650, a display 652, a keyboard 654, a pointing device 656, a peripheral device 658, and a bus 660.

Processor 610 may be a general purpose processor or an application specific integrated circuit (ASIC). Memory device 620 may be a dynamic random access memory (DRAM) device, a static random access memory (SRAM) device, a flash memory device, or a combination of these memory devices. I/O controller 650 may include a communication module for wired or wireless communication.

One or more or the components shown in system 600 may be included in one or more integrated circuit packages. For example, processor 610, or memory device 620, or at least a portion of I/O controller 650, or a combination of these components may be included in an integrated circuit package such as package 100 of FIG. 1. Thus, one or more or the components shown in system 600 may be included in a package, in which the package includes at least one TFC embedded in a package substrate such as TFC 111 of FIG. 1, TFC 211 of FIGS. 2G, 2H and 2I and 311 of FIG. 3

System 600 may include computers (e.g., desktops, laptops, hand-held devices, servers, Web appliances, routers, etc.), wireless communication devices (e.g., cellular phones, cordless phones, pagers, personal digital assistants, microphones, etc.), computer-related peripherals (e.g., printers, scanners, monitors, etc.), entertainment devices (e.g., televisions, radios, stereos, tape and compact disc players, mini-disk players, micro-disk players, digital versatile disk (DVD) players, electronic musical instruments, electronic toys, video cassette recorders, camcorders, digital cameras, Motion Picture Experts Group, Audio Layer 3 (MP3) players, video games, watches, etc.), to include geoposition (GPS) sources and RF devices (transmitters, receivers), such as low power RF devices having a specific capacitance within the range of about 16 to about 18 nF/cm², although other devices known in the art may also be included.

The above description and the drawings sufficiently illustrate some specific embodiments sufficiently to enable those skilled in the art to practice the embodiments. Other embodiments may incorporate structural, logical, electrical, process, and other changes. In the drawings, like features or like numerals describe substantially similar features throughout the several views. Examples merely typify possible variations. Portions and features of some embodiments may be included in, or substituted for, those of others. Many other embodiments will be apparent to those of skill in the art upon reading and understanding the above description. Therefore, the scope of various embodiments is determined by the appended claims, along with the full range of equivalents to which such claims are entitled.

It can now be appreciated that embodiments set forth in this disclosure can be applied to devices and apparatuses other than a traditional computer. For example, a die can be packaged with an embodiment(s) configuration, and placed in a portable device such as a wireless communicator or a hand-held device such as a personal digital assistant and the like. Another example is a die that can be packaged with an embodiment(s) configuration and placed in a vehicle such as an automobile, a locomotive, a watercraft, an aircraft, or a spacecraft.

The Abstract is provided to comply with 37 C.F.R. § 1.72(b) requiring an abstract that will allow the reader to quickly ascertain the nature and gist of the technical disclosure. It is submitted with the understanding that it will not be used to interpret or limit the scope or meaning of the claims.

In the foregoing Detailed Description, various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate preferred embodiment.

It will be readily understood to those skilled in the art that various other changes in the details, material, and arrangements of the parts and method stages which have been described and illustrated in order to explain the nature of this invention may be made without departing from the principles and scope of the invention as expressed in the subjoined claims.

What is claimed is:

1. A method comprising:
forming a first conductive layer over a substrate;
patterning the first conductive layer to form a patterned first conductive layer;
forming a polymer-based dielectric layer over the patterned first conductive layer;
curing the polymer-based dielectric layer; and
forming a second conductive layer over the polymer-based dielectric layer.

2. The method of claim 1 further comprising forming traces on the first conductive layer and the second conductive layer.

3. The method of claim 1, wherein the polymer-based dielectric layer is deposited onto the substrate at about room temperature.

4. The method of claim 3 wherein the polymer-based dielectric layer is deposited onto the substrate with a squeegee.

5. The method of claim 4, wherein the polymer-based dielectric layer is cured at a temperature of about 200° C. or lower.

6. The method of claim 5, wherein depositing the polymer-based dielectric layer and curing the polymer-based dielectric layer are performed in situ.

7. The method of claim 3, wherein the polymer-based dielectric layer is made using a polymer composite comprising a polymeric material blended with a filler.

8. The method of claim 7 wherein the polymeric material is a ferroelectric material.

9. The method of claim 8 wherein the ferroelectric material is selected from the group consisting of nylon-11, polyvinylidene fluoride, poly(vinylidene fluoride-trifluorethylene, poly(vinylidene fluoride-tetrafluorethylene), and combinations thereof.

10. The method of claim 8 wherein the ferroelectric material is an electrostrictive ferroelectric material.

11. The method of claim 7 wherein the filler is a plurality of metallophthalocyanine oligomer particles.

12. The method of claim 11 wherein each of the plurality of metallophthalocyanine oligomer particles has a structure comprising: 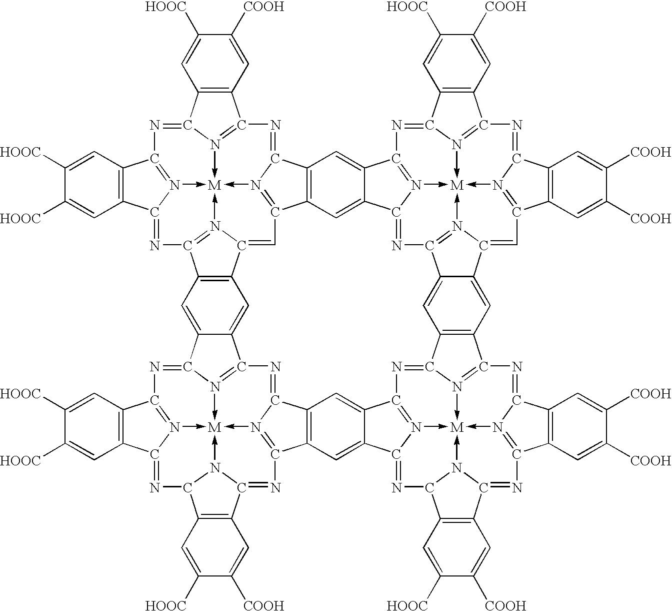
wherein M=Cu, Cr, Mn, Fe, Co or Ni.

13. The method of claim 12 wherein M=Cu and each copper phthalocyanine particle has a particle size less than about one (1) micrometer.

14. The method of claim 1 further comprising forming the polymer composite material.

15. The method of claim 7, wherein the polymer-based dielectric layer has a dielectric constant between about 2000 and about 5,000.

16. The method of claim 7 wherein the polymer-based dielectric layer has a coefficient of thermal expansion, wherein the coefficient of thermal expansion is between about 12×10⁻⁶/° C. and about 30×10⁻⁶/° C.

17. The method of claim 2, wherein the first conductive layer, the polymer-based dielectric layer, the traces and the second conductive layer are parts of a capacitor.

18. The method of claim 17 wherein the capacitor is a decoupling capacitor.

19. The method of claim 18 wherein the decoupling capacitor is part of a low power radio frequency device and has a capacitance in the range of about 16 to about 18 nanofarad/cm².

20. A method comprising:
providing an apparatus comprising an organic substrate;
providing a first capacitor electrode layer overlaying the organic substrate;
providing a polymer-based dielectric layer overlaying the first capacitor electrode layer; and
providing a second capacitor electrode layer overlaying the polymer-based dielectric layer.

21. The method of claim 20, wherein the polymer-based dielectric layer is a polymer composite comprising between about 40 wt % and about 55 wt % of copper phthalocyanine filler blended in a poly(vinylidene fluoride-trifluorethylene) epoxy.

22. The method of claim 21, wherein the polymer-based dielectric layer is part of a radio frequency device and has a thickness of less than about 0.5 micrometers.

23. An apparatus comprising:
an organic substrate;
a first capacitor electrode layer overlaying the organic substrate;
a polymer-based dielectric layer overlaying the first capacitor electrode layer; and
a second capacitor electrode layer overlaying the polymer-based dielectric layer.

24. The apparatus of claim 23, wherein the second capacitor electrode layer is coupled to a first contact of the organic substrate through a first conductive segment, wherein the second capacitor electrode layer is coupled to a second contact of the organic substrate through a second conductive segment, wherein the first and second conductive segments are separated by a portion of the organic substrate.

25. The apparatus of claim 24, wherein at least a portion of the first conductive segment is formed in a first via, and wherein at least a portion of the second conductive segment is formed in a second via.

26. The apparatus of claim 23 further comprising:
a first conductive path extending through a first opening of the polymer-based dielectric layer, the first conductive path being coupled to the first capacitor electrode layer; and
a second conductive path extending through a second opening of the polymer-based dielectric layer, the second conductive path being coupled to the second capacitor electrode layer.

27. The apparatus of claim 20 further comprising a die attached to the organic substrate, wherein the die and the organic substrate are parts of an integrated circuit.

28. A system comprising:
an integrated circuit including:
an organic substrate;
a first capacitor electrode layer overlaying the organic substrate;
a polymer-based dielectric layer overlaying the first capacitor electrode layer;
a second capacitor electrode layer overlaying the polymer-based dielectric layer;
an integrated circuit coupled to the organic substrate; and
a dynamic random access memory device coupled to the integrated circuit.

29. The system of claim 28 further comprising:
a first conductive path extending through a first opening of the polymer-based dielectric layer, the first conductive path being coupled to the first capacitor electrode layer; and
a second conductive path extending through a second opening of the polymer-based dielectric layer, the second conductive path being coupled to the second capacitor electrode layer.

30. The system of claim 29, wherein the at least a portion of the first conductive path extends through the organic substrate, and wherein the at least a portion of the second conductive path extends through the organic substrate.
